(19) United States
(12) Patent Application Publication
(10) Pub. No.: US 2026/0192866 A1
(43) Pub. Date: Jul. 9, 2026

(54) REAR PANEL

(71) Applicant: TOYOTA JIDOSHA KABUSHIKI KAISHA, Aichi-ken (JP)

(72) Inventors: Masaro KIMBA, Toyota-shi (JP); Sho ICHII, Kiyosu-shi (JP)

(21) Appl. No.: 19/405,403

(22) Filed: Dec. 2, 2025

(30) Foreign Application Priority Data
Jan. 7, 2025 (JP) 2025-002136

(51) Int. Cl. B62D 33/023

(52) U.S. Cl. CPC B62D 33/023

(57) ABSTRACT

A rear panel that separates the cabin and the deck from each other has a through hole through which an electrodeposition liquid flows during electrodeposition coating, the through hole having a front surface and a rear surface communicating with each other.

### CROSS REFERENCE TO RELATED APPLICATION

This application claims priority to Japanese Patent Application No. 2025-002136 filed on Jan. 7, 2025, which is incorporated herein by reference in its entirety including the specification, claims, drawings, and abstract.

### TECHNICAL FIELD

The present disclosure relates to a structure of a rear panel that partitions a vehicle cabin and a deck.

### BACKGROUND

JP2003-182424A discloses a pickup truck including a cabin with a plurality of seats and a deck separated by a rear panel provided behind a rear seat. It is disclosed that the rear panel is provided with an opening that communicates the cabin with the deck and a panel that opens and closes the opening.

### SUMMARY

In a vehicle including a rear panel that separates a cabin from a deck, the body may be obliquely immersed in an electrodeposition liquid. At this time, the electrodeposition liquid does not flow between the cabin and the deck, and buoyancy may occur in the deck or the cabin. For this reason, the coating process may be restricted by, for example, immersing the body in the electrodeposition liquid in the vertical direction.

Accordingly, it is an object of the present disclosure to reduce the limitation of the coating process of the body.

A rear panel of the present disclosure is a rear panel that partitions a cabin and a deck of a vehicle and has at least one through hole. At least one through hole extending through the rear panel and connecting a cabin-side surface and a deck-side surface and through which an electrodeposition liquid flows during electrodeposition coating.

As a result, when the body is immersed in the electrodeposition liquid in an oblique direction, the electrodeposition liquid flows between the cabin side and the deck side through the through holes. Therefore, the body can be immersed in the electrodeposition liquid in an oblique direction, or the body can be immersed in the electrodeposition liquid in a vertical direction, so that the limitation of the coating process of the body can be reduced.

The rear panel of the present disclosure may further include at least one cover for closing the at least one through hole.

By attaching the cover to the through hole after the electrodeposition coating, rainwater can be prevented from entering the cabin from the deck.

The rear panel of the present disclosure may further include a bead portion a beaded portion formed to conform to the shape of the at least one through hole.

It is possible to compensate for a decrease in rigidity of the rear panel due to the provision of the through hole, and to suppress concentration of stress on the periphery of the through hole. Further, it is possible to suppress deformation of the rear panel when an impact force from the load is applied to the rear panel at the time of a front collision of the vehicle.

The rear panel of the present disclosure may further include a left side portion and a right side portion to be attached to a vehicle body, wherein the at least one through hole includes a left through hole provided between the left side portion and a center portion in the vehicle width direction, and a right through hole provided between the right side portion and the center portion in the vehicle width direction. The beaded portion includes a central bead disposed between the left through hole and the right through hole, a left inclined bead extending obliquely upward along a shape of an upper edge of the left through hole from an upper left portion of the central bead toward the left side portion, a right inclined bead extending obliquely upward along a shape of an upper edge of the right through hole from an upper right portion of the central bead toward the right side portion, a left lateral bead extending in the vehicle width direction along a lower edge of the left through hole from a left lower portion of the central bead toward the left side portion, a right lateral bead extending in the vehicle width direction along a lower edge of the right through hole from a right lower portion of the central bead toward the right side portion.

In this way, it is possible to compensate for the decrease in rigidity of the rear panel due to the provision of the through hole, and to more reliably suppress the concentration of stress on the peripheral edge of the through hole. Further, the deformation of the rear panel when the impact force from the load is applied to the rear panel at the time of the front collision of the vehicle can be more reliably suppressed.

The rear panel of the present disclosure may further include a reinforcing member attached to an upper portion to connect the left side portion and the right side portion. The beaded portion includes a plurality of vertical beads disposed above the central bead, the left inclined bead, or the right inclined bead and extending upward from the central bead, the left inclined bead, or the right inclined bead.

Accordingly, the rigidity of the rear panel at the upper portion of the through hole can be increased.

The present disclosure can reduce the limitations of the body painting process.

### BRIEF DESCRIPTION OF DRAWINGS

FIG. 1 is a perspective view of a vehicle including a rear panel according to an embodiment;

FIG. 2 is an elevation view showing a rear surface of the rear panel of the embodiment;

FIG. 3 is an elevation view showing a front surface of the rear panel of the embodiment;

FIG. 4 is a cross-sectional view of the deck including the rear panel according to the embodiment, and is a cross-sectional view taken along line A-A in FIG. 2;

FIG. 5 is a detailed view of a portion C shown in FIG. 4;

FIG. 6 is a cross-sectional view of the deck including the rear panel according to the embodiment, and is a cross-sectional view taken along line B-B in FIG. 2;

FIG. 7 is an explanatory view showing an electrodeposition coating step.

### DESCRIPTION OF EMBODIMENTS

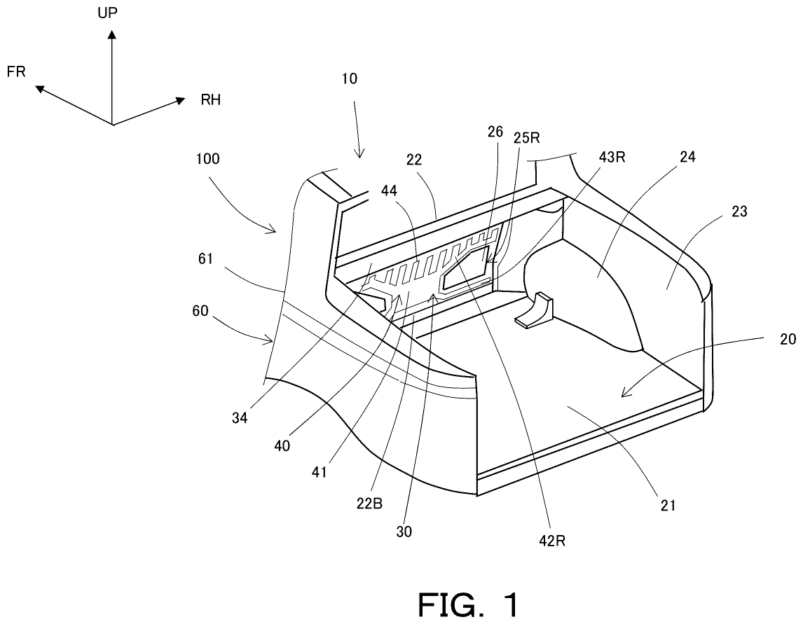

Hereinafter, the rear panel 22 of the embodiment will be described with reference to the drawings. First, vehicle 100 including the rear panel 22 will be described. As shown in FIG. 1, the vehicle 100 includes a cabin 10 disposed on the front side and a deck 20 disposed on the rear side. The deck 20 includes a floor panel 21, left and right side panels 23, and a rear panel 22. A wheel house 24 protrudes from the deck 20. The rear panel 22 is a plate member that partitions the cabin 10 and the deck 20. Note that FR, UP, and RH shown in the drawings indicate the front side, the upper side, and the right side of the vehicle 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the vehicle 100 are indicated unless otherwise specified.

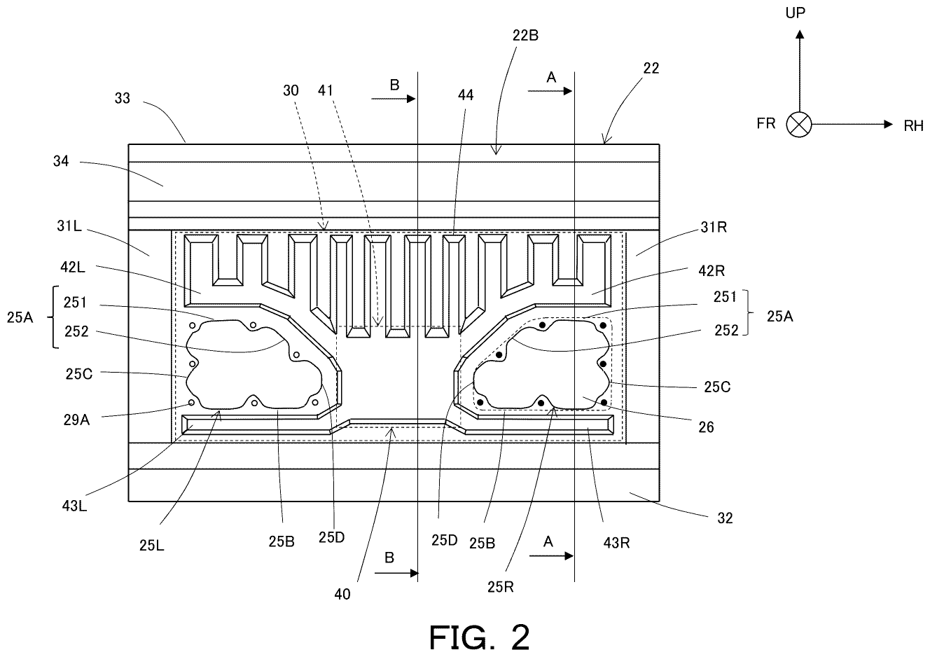

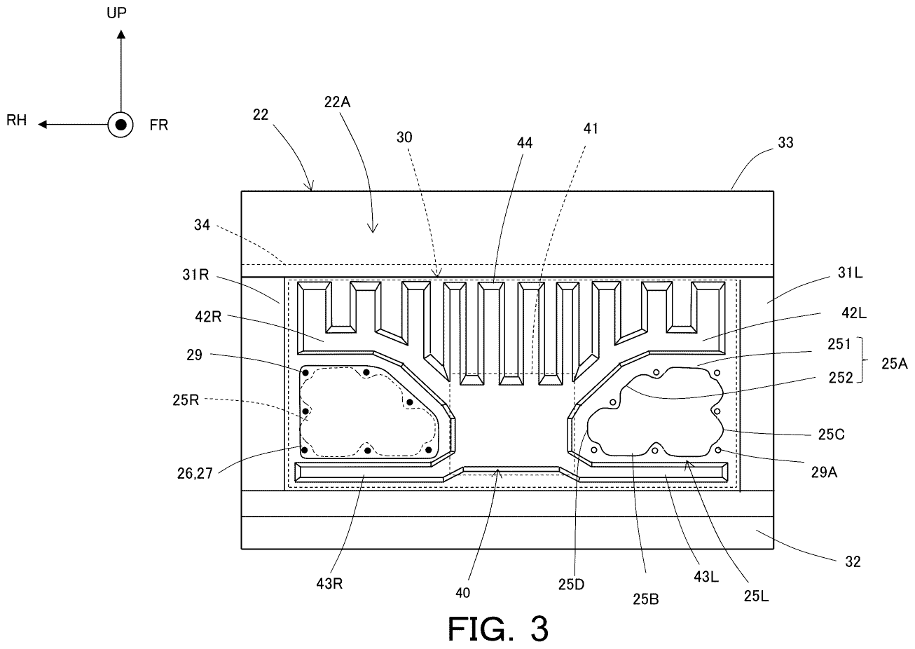

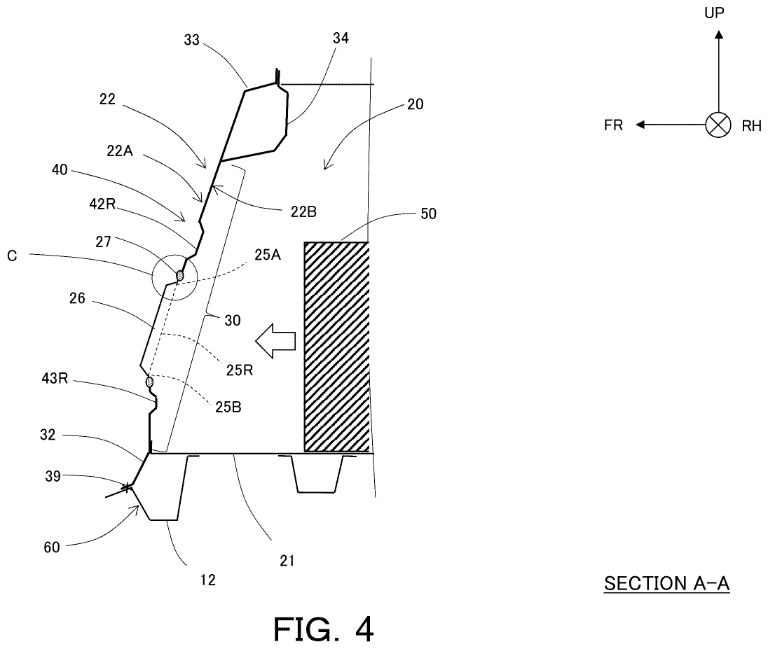

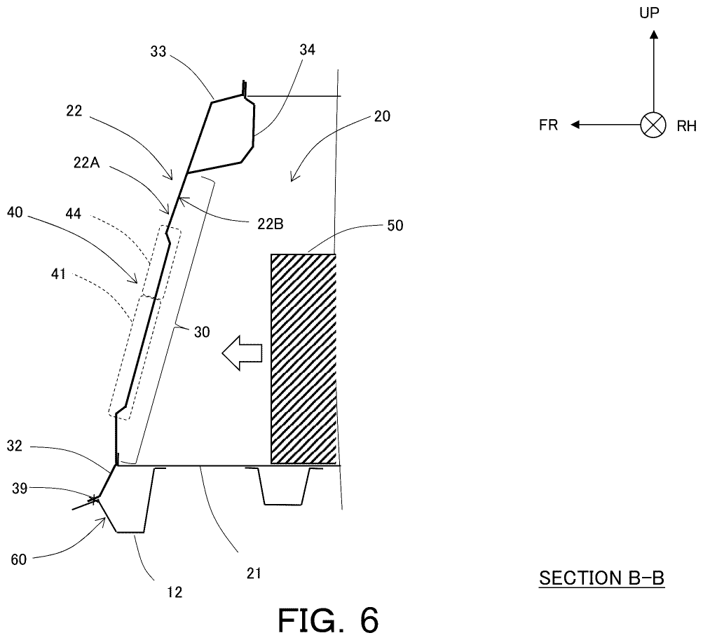

As shown in FIGS. 2 and 3, the rear panel 22 is a rectangular plate member including a left side portion 31L, a right side portion 31R, a lower portion 32, and an upper portion 33. The left side portion 31L and the right side portion 31R are portions connected to the left and right rear pillars 61 of the body 60 of the vehicle 100. The lower portion 32 is a portion of the body 60 that is welded to the cross member 12. The lower portion 32 is combined with the cross member 12 to form a closed cross-sectional structure extending in the vehicle width direction (see FIGS. 4 and 6). The X mark shown in FIGS. 4 and 6 indicates the welded portion 39. A reinforcing member 34 is attached to the deck side of the upper portion 33. The reinforcing member 34 is combined with the upper portion 33 to form a closed cross-sectional structure extending in the vehicle width direction.

As shown in FIGS. 2 and 3, a left through hole 25L and a right through hole 25R communicating with the front surface 22A and the rear surface 22B are provided in the inner region 30 surrounded by the left side portion 31L, the right side portion 31R, the lower portion 32, and the reinforcing member 34 of the rear panel 22. Here, the front surface 22A is a cabin side surface, and the rear surface 22B is a deck side surface. The left and right through holes 25L and 25R are holes through which the electrodeposition liquid 72 flows between the front surface 22A and the rear surface 22B during electrodeposition coating. The left and right through holes 25L and 25R are defined by an upper edge 25A, a lower edge 25B, an outer vertical edge 25C, and an inner vertical edge 25D. The upper edge 25A is composed of a horizontal portion 251 extending in the horizontal direction and an inclined portion 252 obliquely connecting the upper ends of the horizontal portion 251 and the inner vertical edge 25D. A plurality of bolt holes 29A are disposed at peripheral edge portions of the upper edge 25A, the lower edge 25B, the outer vertical edge 25C, and the inner vertical edge 25D.

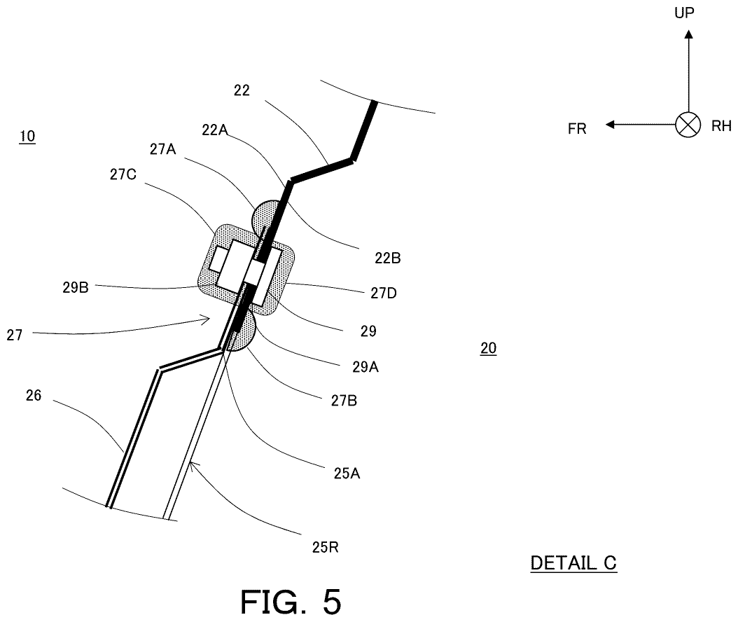

The right through hole 25R is closed by the cover 26. The cover 26 is attached to the front surface 22A of the rear panel 22 by bolts 29 and nuts 29B (see FIGS. 4 and 5). In FIGS. 2 and 3, the left through hole 25L is shown in a state before the cover 26 is attached. Similarly to the right through hole 25R, the left through hole 25L is also closed by the cover 26.

As shown in FIG. 4, the outer peripheral portion of the cover 26 and the peripheral portion of the right through hole 25R are sealed with a sealing material 27. Similarly, the peripheral edge portion of the bolt 29 and the right through hole 25R and the peripheral edge portion of the nut 29B and the right through hole 25R are also sealed by the sealing material 27.

More specifically, as shown in FIG. 5, the sealing material 27 includes a front seal portion 27A that seals between the outer peripheral portion of the cover 26 and the front surface 22A of the rear panel 22, a rear seal portion 27B that seals between the outer peripheral portion of the cover 26 and the rear surface 22B of the rear panel 22, a nut seal portion 27C that seals between the outer peripheral surface of the nut 29B and the cover 26, and a bolt seal portion 27D that seals between the head portion of the bolt 29 and the rear surface 22B. The left through hole 25L, the cover 26, the bolt 29, and the nut 29B are also sealed by the sealing material 27.

As shown in FIGS. 2, 3, and 6, a bead portion 40 is disposed in the inner region 30 of the rear panel 22. The bead portion 40 includes a center bead 41, left and right inclined beads 42L and 42R, left and right lateral beads 43L and 43R, and a plurality of vertical beads 44.

The center bead 41 is a rectangular portion that is disposed at the vehicle width direction center between the left and right through holes 25L and 25R and protrudes toward the vehicle rear side. The left and right ends of the center bead 41 extend in the vertical direction along the inner vertical edges 25D of the left and right through holes 25L and 25R.

The left inclined bead 42L is a protrusion extending obliquely upward from the left upper side portion of the center bead 41 toward the left side portion 31L. Specifically, the left inclined bead 42L extends obliquely upward to the left along the inclined portion 252 of the left through hole 25L from the upper left portion of the center bead 41, and then extends leftward along the horizontal portion 251. In this way, the left inclined bead 42L extends obliquely upward to the left along the shape of the upper edge 25A. The right inclined bead 42R is bilaterally symmetrical to the left inclined bead 42L. Similarly to the left inclined bead 42L, the right inclined bead 42R extends obliquely upward to the right along the shape of the upper edge 25A. As shown in FIG. 4, the left and right inclined beads 42L and 42R protrude toward the rear of the vehicle similarly to the center bead 41.

The left lateral bead 43L is a protrusion extending laterally from the left lower portion of the center bead 41 toward the left side portion 31L. The left lateral bead 43L extends obliquely downward to the left from the lower left portion of the center bead 41, and then extends leftward along the lower edge 25B of the left through hole 25L. Thus, the left lateral bead 43L extends to the left along the shape of the lower edge 25B. The right lateral bead 43R is bilaterally symmetrical to the left lateral bead 43L. Similarly to the left lateral bead 43L, the right lateral bead 43R extends in the right direction along the shape of the lower edge 25B. As shown in FIG. 4, the left and right lateral beads 43L and 43R protrude toward the rear of the vehicle similarly to the center bead 41.

The plurality of vertical beads 44 are disposed above the center bead 41 and the left and right inclined beads 42L and 42R. The plurality of vertical beads 44 are protruding portions extending upward from the upper portion of the center bead 41 or the upper portions of the left and right inclined beads 42L and 42R toward the reinforcing member 34. As shown in FIGS. 2 and 6, each vertical bead 44 protrudes toward the vehicle rear side, and the lower portion of each vertical bead 44 is connected to the upper portion of the center bead 41 or the upper portions of the left and right inclined beads 42L and 42R.

Next, with reference to FIGS. 4 and 6, a flow of impact force when the load 50 mounted on the deck 20 collides with the rear panel 22 at the time of a front collision of the vehicle 100 will be described.

A part of the impact load input to the center bead 41 is transmitted to the left and right side portions 31L and 31R by the left and right inclined beads 42L and 42R, and is transmitted from the left and right side portions 31L and 31R to the body 60 of the vehicle 100. A part of the impact load input to the center bead 41 is transmitted to the left and right side portions 31L and 31R by the left and right lateral beads 43L and 43R, and is transmitted from the left and right side portions 31L and 31R to the body 60 of the vehicle 100.

Thus, the impact load from the load 50 when the vehicle 100 collides forward is transmitted from the left and right side portions 31L and 31R to the body 60, and the impact load applied to the welded portion 39 between the lower portion 32 of the rear panel 22 and the body 60 is dispersed, so that damage to the welded portion 39 can be suppressed.

In addition, since the left and right lateral beads 43L and 43R are disposed along the lower portion 32 and the left and right lateral beads 43L and 43R receive the impact load when the load 50 collides, the impact load received by the welded portion 39 can be reduced.

A part of the impact load input to the plurality of vertical beads 44 is transmitted from the plurality of vertical beads 44 to the reinforcing member 34, and is transmitted from the left and right end portions of the reinforcing member 34 to the body 60 of the vehicle 100. Accordingly, the rigidity of the rear panel 22 at the upper portions of the left and right through holes 25L and 25R can be increased, and the impact load input to the upper portion of the rear panel 22 can be received by the body 60.

As described above, the deformation of the rear panel 22 can be suppressed by causing the impact load when the impact load from the load 50 when the vehicle 100 collides forward to flow to the body 60 when the impact load is applied to the rear panel 22. In addition, as a result, it is possible to suppress concentration of a load on each edge of the left and right through holes 25L and 25R, and it is possible to suppress damage to the left and right through holes 25L and 25R and the cover 26 due to a collision load.

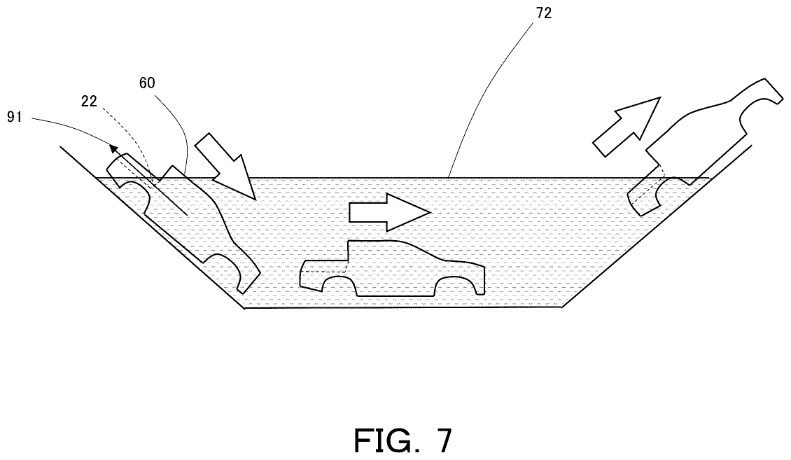

Next, a process of electrodeposition coating of the body 60 to which the rear panel 22 is attached will be described with reference to FIG. 7. As shown by the outlined arrows in FIG. 7, in the electrodeposition coating, the body 60 to which the rear panel 22 is attached is immersed in the electrodeposition liquid 72 in an oblique direction. At this time, as indicated by an arrow 91 in FIG. 7, the electrodeposition liquid 72 flows between the front surface 22A on the cabin side and the rear surface 22B on the deck side through the left and right through holes 25L and 25R. As a result, it is possible to suppress the application of buoyancy to the body 60 when the body 60 is obliquely immersed in the electrodeposition liquid 72. Therefore, the body 60 provided with the rear panel 22 can be immersed in the electrodeposition liquid 72 in an oblique direction, or the body 60 can be immersed in the electrodeposition liquid 72 in a vertical direction. In this way, the limitation of the coating process of the body 60 can be reduced.

As described above, since the rear panel 22 includes the center bead 41, the left and right inclined beads 42L and 42R, and the left and right lateral beads 43L and 43R around the left and right through holes 25L and 25R, it is possible to compensate for the decrease in rigidity in the vicinity of the left and right through holes 25L and 25R and to maintain the rigidity of the rear panel 22 high. Accordingly, when the vehicle 100 collides with the rear panel 22 due to a front collision, it is possible to suppress concentration of a load on each edge of the left and right through holes 25L and 25R, and it is possible to suppress damage to the left and right through holes 25L and 25R and the cover 26 due to the collision load.

In addition, since the cover 26 is attached to the left and right through holes 25L and 25R, and the cover 26 and the front surface 22A of the rear panel 22, the cover 26 and the rear surface 22B, the nut 29B and the cover 26, and the head portion and the rear surface 22B of the bolt 29 are sealed with the sealing material 27, it is possible to prevent water or the like from entering the cabin 10 from the deck 20 due to breakage of the sealing material 27 when the load 50 collides with the rear panel 22.

Further, since the rear panel 22 is provided with the left and right through holes 25L and 25R through which the electrodeposition liquid 72 flows, it is possible to reduce the limitation of the coating process of the body 60.

1. A rear panel for partitioning a cabin and a deck of a vehicle, comprising:
at least one through hole extending through the rear panel and connecting a cabin-side surface and a deck-side surface and through which an electrodeposition liquid flows during electrodeposition coating.

2. The rear panel according to claim 1, further comprising:
at least one cover for closing the at least one through hole.

3. The rear panel according to claim 2, further comprising:
a beaded portion formed to conform to the shape of the at least one through hole.

4. The rear panel according to claim 3, further comprising:
a left side portion and a right side portion to be attached to a vehicle body, wherein the at least one through hole includes
a left through hole provided between the left side portion and a center portion in the vehicle width direction, and
a right through hole provided between the right side portion and the center portion in the vehicle width direction,
the beaded portion includes
a central bead disposed between the left through hole and the right through hole,
a left inclined bead extending obliquely upward along a shape of an upper edge of the left through hole from an upper left portion of the central bead toward the left side portion,
a right inclined bead extending obliquely upward along a shape of an upper edge of the right through hole from an upper right portion of the central bead toward the right side portion,
a left lateral bead extending in the vehicle width direction along a lower edge of the left through hole from a left lower portion of the central bead toward the left side portion,
a right lateral bead extending in the vehicle width direction along a lower edge of the right through hole from a right lower portion of the central bead toward the right side portion.

5. The rear panel according to claim 4, further comprising:
a reinforcing member attached to an upper portion to connect the left side portion and the right side portion, wherein
the beaded portion includes a plurality of vertical beads disposed above the central bead, the left inclined bead, or the right inclined bead and extending upward from the central bead, the left inclined bead, or the right inclined bead.
